(19) United States
(12) Patent Application Publication
(10) Pub. No.: US 2011/0209811 A1
(43) Pub. Date: Sep. 1, 2011

(54) Production Process For Parts Of A Perfluoropolymer Composition

(75) Inventors: J. David Booze, Wilmington, DE (US); Clifford K. Deakyne, Wilmington, DE (US); Thomas P. Gannett, Wilmington, DE (US)

(73) Assignee: E. I. DU PONT DE NEMOURS AND COMPANY, Wilmington, DE (US)

(21) Appl. No.: 13/103,446

(22) Filed: May 9, 2011

Related U.S. Application Data
(62) Division of application No. 12/002,975, filed on Dec. 19, 2007.
(60) Provisional application No. 60/876,836, filed on Dec. 22, 2006.

(51) Int. Cl. B29C 65/06

(52) U.S. Cl. 156/73.5

(57) ABSTRACT

Perfluoropolymer parts containing (reinforcing) fibers oriented parallel to the surface of the parts may be joined by frictional welding processes such as vibration welding and ultrasonic welding without disturbing the orientation of the fibers. The parts may be used directly or cut into other shapes. Such parts are useful where high temperature resistance and/or chemical resistance is desired along with good physical properties such as strength and/or toughness. These types of parts include gaskets and seal rings.

### CROSS-REFERENCE TO RELATED APPLICATION

This application is a division of U.S. application Ser. No. 12/002,975 filed Dec. 19, 2007, now pending, which claims the benefit of U.S. Provisional Application No. 60/876,836, filed Dec. 22, 2006; the entire disclosures of the prior applications are herein incorporated by reference.

### FIELD OF THE INVENTION

The present invention relates to a process for welding perfluoropolymer parts containing long fibers. The present invention particularly relates to a process for frictionally welding perfluoropolymer parts that include long fibers oriented essentially parallel to a plane without substantially disturbing the orientation of the fibers.

### BACKGROUND OF THE INVENTION

Sheets of perfluoropolymers which are thermoplastics and which contain continuous or long fibers oriented parallel to the major plane of the sheet (the so-called x-y plane, as opposed to the z axis through the thickness of the sheet) are known (see, e.g., U.S. Pat. Nos. 4,163,740; 5,194,484; 5,232,975; 5,470,409; 5,503,662; and 5,506,052, all of which are hereby incorporated by reference). However the prior art does not describe a process for welding together fiber reinforced perfluoropolymer material wherein the fibers are oriented in an x-y plane without disturbing the fiber orientation.

Another disadvantage of the conventional methods is that the thickness of sheets obtained by conventional welding methods is limited somewhat by the process. For example, when thick sheets are desirable, consolidation of the matrix polymer may not be complete. Thicker pieces, for example pieces having a nominal thickness of greater than 0.05 cm, can be obtained by compression molding several sheets together. However, such a process can be time consuming if relatively thick sheets are desired, because thermal stresses may cause cracking or other defects if the heating and/or cooling rates are too high. In manufacturing processes it is typically a balance sought between production quality and production efficiency. It can be desirable to have a more rapid method for obtaining such thick parts, while avoiding substantial changes in the fiber orientation.

### SUMMARY OF THE INVENTION

In one aspect the present invention is a process for forming a part comprising a perfluoropolymer or a polychlorotrifluoroethylene polymer, the process comprising the steps of:
(a) contacting a flat surface of a first part comprising a perfluoropolymer with a flat surface of a second part comprising a perfluoropolymer or a polychlorotrifluoroethylene polymer, said first and second parts comprising fibers oriented essentially parallel to a plane of said flat surfaces;
(b) maintaining contact between said flat surfaces of said first and second parts while moving said first part and said second part in relationship to one another in order to create sufficient frictional heat between said first and second parts whereby the respective flat surfaces of said first and second parts melt and/or soften; and,
(c) halting the motion of said first and second parts while maintaining contact between said flat surfaces for a time sufficient to allow the flat surfaces of said first and second parts to cool and adhere to one another.

Another aspect is for a part formed by a process of the present invention.

### BRIEF DESCRIPTION OF THE FIGURE

FIG. 1 illustrates two perfluoropolymer parts of the present invention which have been vibration welded together. The scale and weld line are marked in the FIGURE, and one can see that the orientations of the fibers at the weld line have not been changed.

### DETAILED DESCRIPTION OF THE INVENTION

Herein certain terms are used and some of them are defined below:

By the “x-y plane” of a sheet or a flat surface is meant a plane parallel to the surface of the designated surface. The “z” direction is perpendicular to the x-y plane.

By “in contact” it means two (or more) items actually touching, and they may be contacted with very little pressure (force) or much pressure.

By a “sheet” is meant a form with two principal surfaces, preferably parallel to each other, which has edges. The x-y plane of the sheets is parallel to at least one of the surfaces, preferably both of the surfaces. The “z” direction is through the thickness of the sheet. Preferably the sheet thickness is less than 20%, more preferably less than 10% of the smallest linear dimension of a surface of the sheet. As used herein, a sheet of the present invention need not be in the form of a square or rectangle, rather it may also be a “preform” that approximates the desired shape of the finished article, but wherein the thickness of the final article requires more than a single sheet. For example, if some type of ring is being made, the sheet may be doughnut shaped, although the two principal surfaces are flat, and the ring may comprise several thicknesses of the sheet used to obtain the ring.

By “fibers oriented essentially parallel to an x-y plane” is meant that the long axis of the fibers is oriented parallel to the x-y plane. The long axis of a fiber may be bent, but that long axis will generally be parallel to the x-y plane.

In one embodiment, a sheet used in the process of the present invention comprises perfluoropolymers. One of ordinary skill would know that a perfluoropolymer is a synthetic organic polymer where essentially all of the hydrogen atoms have been replaced by fluorine atoms. For the purposes of the present invention, such polymers comprise less than 0.5 weight percent hydrogen, more preferably less than 0.2 weight percent and very preferably less than 0.1 percent hydrogen. Alternatively fluoropolymers, wherein at least some but not all of the hydrogen atoms have been replaced by fluorine atoms, are suitable for use in the same manner as perfluoropolymers. Perfluoropolymers are preferred.

Frictional welding of polymers such as thermoplastics is well known, and there are several principal “types” used, all of which are applicable herein. Vibrational welding simply means that the two parts, usually flat where they are to be welded, are brought into contact with one another under a given pressure and the two parts are moved in a repetitive motion with respect to one another at relatively low frequencies, such as about 150 Hz to about 300 Hz, preferably about 170 Hz to about 250 Hz. When the surfaces are sufficiently melted and/or softened, movement is stopped and contact is maintained between the parts until the thermoplastic solidifies or hardens and the parts are bonded. The motion of one part relative to the other may be linear (that is, in straight lines), circular (that is, radial or curved lines), random (that is, non-repetitive motions), or any combination of these, although linear movement is preferred.

In another type of frictional welding, the parts are brought together as above, but the frequency of the motion is much higher, in the ultrasonic range, typically 15 kHz to 50 kHz. Again the motion may be linear, circular, random or any combination of motion.

Spin welding may also be used, particularly for circular parts. In spin welding, the parts are brought together as above, but now the motion is circular with respect to one another, the speed (rpm) and pressure applied being sufficient to melt or soften the thermoplastic. However since the section of the surface nearer the axis of rotation is moving more slowly than the outer sections, this method is best applied to items having ring-like shapes with flat surfaces. A preferred welding method is vibrational welding.

In one preferred embodiment, one or both of the first and second parts are perfluoropolymer sheets. Two such sheets may be welded together and the resulting part may then be welded to a third single sheet, and repeatedly so until a part of the desired thickness is produced. One of ordinary skill would be able to devise other combinations or ways to combine sheets without departing from the scope of the present invention. For example, two or more welded sheets can be welded to another part of two or more welded sheets. Even though multiple welding steps may be needed to produce a part of the desired thickness, the process of the present invention can nonetheless be faster than the conventional compression molding method for producing a part of similar thickness. Preferably, the minimum cross-sectional dimension of the first and second parts is about 0.3 cm or more.

Such thick parts obtained as described herein can be used as is, or alternatively can be trimmed and/or machined and/or subdivided to provide the desired final parts. Because they are made of perfluoropolymers and contain fibers, such parts have exceptional chemical and thermal stability, and have good strength, modulus and/or toughness. They may be used, for example, as seals, gaskets, bushing, tubes, and rings in applications where such properties are needed.

Fibers which have high moduli and/or tensile strength (commonly called reinforcing fibers) are particularly useful. Useful fibers include glass, carbon (graphite), aramid, and carbon are particularly preferred, and carbon is especially preferred. Typical loadings of fibers are at least about 5%, more preferably at least about 10%, and very preferably at least about 15%. Maximum loadings of fiber are typically 65%, more preferably about 50%, and especially preferably about 30%. All such percentages are percents by weight based on the total weight of fiber plus perfluoropolymer in the composition. It is to be understood that any preferred minimum loading may be combined with any preferred maximum loading to form a preferred loading range. Useful fiber “grades” includes those normally used to reinforce thermoplastics.

Preferably the fibers are at least about 0.3 cm long, more preferably at least about 0.6 cm long, very preferably least about 1.3 cm long, and especially preferably at least about 2.5 cm long. The fiber lengths shall be taken to mean the lengths of the fibers actually in the composition.

Other materials that are typically included in perfluoropolymer compositions may also be included in compositions of the present invention. Such materials include pigments in conventional amounts.

Preferably the perfluoropolymers of both the first and second parts are the same, and/or preferred perfluoropolymers may also be thermoplastics. Preferably the perfluoropolymers are made from one or more monomers comprising tetrafluoroethylene (TFE), and more preferably such TFE polymers contain at least 80 mole percent of the repeat units derived from TFE. Useful comonomers with TFE are perfluorinated alkyl vinyl ethers, especially perfluoro(n-propyl vinyl ether), and perfluorinated olefins, especially hexafluoropropylene. Another preferred perfluoropolymer is polyTFE.

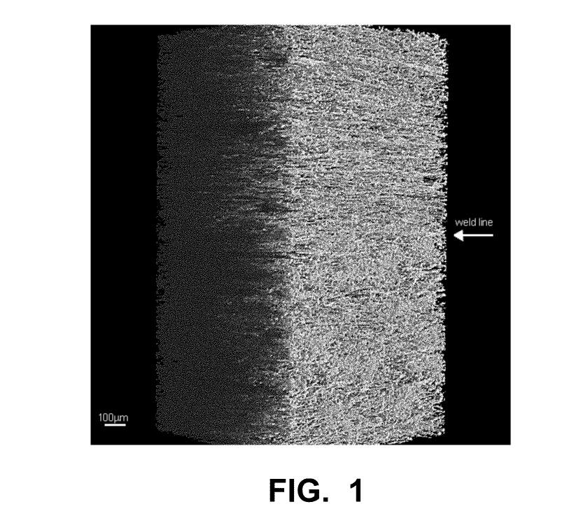

FIG. 1 shows a vibrational weld between two perfluoropolymer sheets containing oriented carbon fiber. The picture was generated by X-ray microtomography, as generally described in A. Sasov and D. van Dyck, Desktop X-Ray Microscopy and Microtomography, Journal of Microscopy, vol. 191, p. 151-158 (1998), which is hereby incorporated by reference. The weld line is marked on the FIGURE, and as can be observed, there is no appreciable change in orientation of the fibers at the weld line.

General procedure, Examples 1-9. Partially consolidated (Note—the parts may be, and are preferred to be, fully consolidated) (95-97%) 0.64 cm (0.25″) thick sheets of Teflon® PFA 340 (a copolymer of tetrafluoroethylene and perfluoro(propyl vinyl ether), available from E. I. du Pont de Nemours and Company, Wilmington, Del. 19898 U.S.A.) reinforced with 20 wt % 0.64 cm (0.25″) long chopped carbon fiber were prepared according to U.S. Pat. No. 5,470,409, which is hereby incorporated by reference. These plates were cut by bandsaw into suitably sized squares. All samples were vibration welded on a Branson® VW-8UHL machine (Branson Ultrasonics Corp., Danbury, Conn. 06813, USA) at 240 Hz with a linear vibration amplitude of 1.78 mm (0.070″). Anti-skid tape was used on the machine platens in lieu of fixturing to prevent slippage of the samples being welded.

### EXAMPLE 1

Two 5.08 cm square (2″×2″) sheets were placed in the welding machine on top of each other. The machine was set to deliver 181 kg (400 lbs.) of clamping force (689 kPa, 100 psi) and to vibrate until a weld depth of 1.27 mm (0.050″) (10% of total welded part thickness) was achieved. Weld depth was not achieved in the 20 sec provided for welding and very little flash was produced. The plates were easily pried apart and showed only localized areas of melting.

### EXAMPLE 2

Two 5.08 cm square (2″×2″) sheets were placed in the welding machine on top of each other. The machine was set to deliver 327 kg (720 lbs.) of clamping force (1.24 MPa, 180 psi) to 1.27 mm (0.050″) weld depth, 20 sec vibration time. The weld displacement was not reached as shown by the flash being 2.1% of the total welded part weight (vs. ˜10% calculated for the 1.27 mm displacement). However, a strong weld was achieved as demonstrated by the failure to be able to drive a wedge through the weld. The welded part specific gravity was 1.99 vs. ˜2.0 for the individual plates.

### EXAMPLE 3

Example 2 was repeated except that the clamping force was raised to 907 kg (2000 lbs.) (3.45 MPa, 500 psi) followed by a hold at 1.72 MPa (250 psi) after the vibration stopped in order to allow the weld melt to freeze under pressure. The full 1.27 mm was achieved as evidence by the production of flash equal to 10.4% of the total welded part weight. Displacement (i.e. start of melting at the interface) commenced about 10 sec after the start of vibration. A good weld was achieved with no gaps around the sides. The welded part specific gravity was 2.01.

### EXAMPLE 4

Two 5.08 cm square (2″×2″) sheets were welded together using a 907 kg (2000 lb) clamping load (3.45 MPa, 500 psi) and a weld displacement setting of 0.64 mm (0.025″). A good weld was obtained with no gaps visible around the edges. Extensive flash was produced, 5.7 wt. % based on the total weight of the welded part. Part specific gravity was 2.03.

### EXAMPLE 5

Two 5.08 cm square (2″×2″) sheets were welded together using a vibration cycle which began with 10 sec at 3.45 MPa (500 psi) followed by 10 sec at 689 kPa (100 psi). Weld displacement was not controlled. Very little flash was produced, 0.3 wt. %, but the weld was good and could not be pulled apart by hand. Part specific gravity was 2.02.

### EXAMPLE 6

Example 5 was repeated except that the vibration time at 3.45 MPa (500 psi) was extended for 10 to 13 sec. The weld strength was tested by driving a wedge (cold chisel and hammer) through the weld. Visual inspection of the separated plates showed failure both along the weld interface and into the bulk material of one of the plates. This shows that the weld strength is comparable to the bulk strength of the plates in the plane of the weld.

### EXAMPLE 7

A 5.08 cm (2″) square, 3.18 cm (1.25″) thick block was constructed by sequential welding of 5 sheets (4 welds). The weld cycle was 14 sec at 3.45 MPa (500 psi) and 10 sec at 689 kPa (100 psi). Total time required was about 6 min including the 60 sec used after each weld cycle to exhaust any polymer fume. All four welds appeared visually good. Estimated flash was 3.5 wt %.

### EXAMPLE 8

Two 8.89 cm (3.5″) square sheets were welded using 2720 kg (6000 lb) load (3.38 MPa, 490 psi) for 24 sec. The weld was visually good but the amount of flash produced was 10.2 wt %. Part specific gravity was 2.02.

### EXAMPLE 9

Example 8 was repeated except that the weld cycle was divided into 14 sec at 3.38 MPa (490 psi) and 10 sec at 676 kPa (98 psi). The weld line was good in appearance and the amount of flash produced was reduced to 2.5 wt %. This example shows that weld time is independent of part area size providing the vibration time/pressure cycle is held constant. Part specific gravity was 1.97.

What is claimed is:

1. A process for forming a part comprising a perfluoropolymer or a polychlorotrifluoroethylene polymer, the process comprising the steps of:
(a) contacting a flat surface of a first part comprising a perfluoropolymer with a flat surface of a second part comprising either a perfluoropolymer or a polychlorotrifluoroethylene polymer, said first and second parts comprising fibers oriented essentially parallel to a plane of said flat surfaces;
(b) maintaining contact between said flat surfaces of said first and second parts while moving said first part and said second part in relationship to one another in order to create sufficient frictional heat between said first and second parts whereby the respective flat surfaces of said first and second parts melt and/or soften; and,
(c) halting the motion of said first and second parts while maintaining contact between said flat surfaces for a time sufficient to allow the flat surfaces of said first and second parts to cool and adhere to one another.

2. The process of claim 1, wherein said moving is a repetitive motion and is done at a frequency of about 150 Hz to about 300 Hz.

3. The process of claim 1, wherein said motion is repetitive and is done at a frequency of about 15 kHz to about 50 kHz.

4. The process of claim 1, wherein the fibers are about 5 weight percent to about 50 weight percent of the parts, based on the total weight of said fluoropolymer and the fiber in the parts.

5. The process of claim 1, wherein the fibers are at least about 0.6 cm long.

6. The process of claim 1, wherein the first part perfluoropolymer and/or the second part perfluoropolymer are copolymers of tetrafluoroethylene or a homopolymer of tetrafluoroethylene.

7. The process of claim 6, wherein the copolymers contain at least 80 weight percent of repeat units derived from tetrafluoroethylene.

8. The process of claim 6, wherein the copolymer is one or more of a copolymer containing a perfluorinated alkyl vinyl ether or a perfluorinated olefin.

9. The process of claim 1, wherein the first and second parts have a minimum cross-sectional measurement of about 0.3 cm or more.

10. The process of claim 1, wherein the fibers are one or more of glass, carbon, or aramid fibers.

11. The process of claim 1, wherein the second part comprises perfluoropolymer.

12. The process of claim 11, wherein the first part perfluoropolymer is the same as the second part perfluoropolymer.
